(19) United States
(12) Patent Application Publication
(10) Pub. No.: US 2025/0135624 A1
(43) Pub. Date: May 1, 2025

(54) ELECTRIC POWER TOOLS

(71) Applicant: MAKITA CORPORATION, Anjo-shi (JP)

(72) Inventors: Masaya NAGAO, Anjo-shi (JP); Norikazu BABA, Anjo-shi (JP)

(73) Assignee: MAKITA CORPORATION, Anjo-shi (JP)

(21) Appl. No.: 18/904,211

(22) Filed: Oct. 2, 2024

(30) Foreign Application Priority Data
Nov. 1, 2023 (JP) 2023-187523

(51) Int. Cl. B25F 5/00; H01M 50/242; H01M 50/247

(52) U.S. Cl. CPC B25F 5/006; H01M 50/242; H01M 50/247; H01M 2220/30

(57) ABSTRACT

A battery holder supported by a main body housing so as to be displaceable in an up-down direction has a main body extension, a holder lower portion at a lower part, and a terminal supported by the battery holder so as to be displaceable in the up-down direction. The battery holder has a first elastic body interposed between the main body housing and the battery holder, a second elastic body interposed between the battery holder and the terminal, and a third elastic body interposed between the holder lower portion and the main body housing. The first to third elastic bodies absorb impacts in the event of a drop, thereby reducing damage to the battery.

### CROSS-REFERENCE TO RELATED APPLICATIONS

This application claims priority to Japanese patent application serial number 2023-187523 filed Nov. 1, 2023, the contents of which are incorporated herein by reference in their entirety for all purposes.

### BACKGROUND

The present disclosure relates to an electric power tool in which a battery can be mounted.

A handheld grinder to which a battery can be mounted is disclosed electric power tool to reduce vibration of the battery during use and to absorb impact on the battery when, for example, dropped. The battery is mounted to a tool body via a battery holder. Protrusions are provided at multiple locations on the battery holder. An elastic member is attached to each protrusion. The battery holder is supported to the tool body via a plurality of elastic members.

More elastic members need to be used, or larger elastic members must be employed to increase the vibration absorption capacity. Such structures tend to increase the size of electric power tools. Therefore, there has been a need for a structure that provides higher vibration damping property and impact resistance of the battery without leading to increase in the size of the electric power tool.

### SUMMARY

According to one aspect of the present disclosure, an electric power tool has a tool body and a battery holder that is supported by a first elastic body (or first elastic bodies) in a displaceable manner that is in an up-down direction with respect to the tool body. The first elastic body is interposed between the tool body and the battery holder. A terminal is supported by the battery holder in a displaceable manner in an up-down direction with respect to a holder main body. The terminal has a connection terminal. A second elastic body is interposed between the holder main body and the terminal. A third elastic body is provided on the tool body. The third elastic body faces a lower surface of a battery that is moved downward from above relative to the battery holder so as to be mounted.

Therefore, the first to third elastic bodies are distributed in three locations to reduce vibration of the battery during use and to absorb impact on the battery when, for example, the battery is dropped. This arrangement improves the vibration damping property and impact resistance of the battery without increasing the size of the electric power tool.

### BRIEF DESCRIPTION OF THE DRAWINGS

FIG. 1 is a left-side view of a driving tool.

FIG. 2 is a cross-sectional view taken along the line II-II in FIG. 1 and a vertical sectional view of a tool body with a driver in a stand-by position.

FIG. 3 is a right-side view of the driving tool with a right housing half removed to expose an interior of the driving tool.

FIG. 4 is a right-side view of a battery mount. This view illustrates a state in which the right housing half is removed.

FIG. 5 is a perspective view of the battery holder as viewed diagonally from behind on the right.

FIG. 6 is a perspective view of the single battery holder as viewed diagonally from the front on the right.

FIG. 7 is a right-side view of the single battery holder.

FIG. 8 is a perspective view of the battery holder with the right holder half removed.

FIG. 9 is a perspective view of the battery mount with the right housing half and battery holder removed.

FIG. 10 is a perspective view of a battery.

FIG. 11 is a side view illustrating that the electric power tool is dropped on a floor.

### DETAILED DESCRIPTION

According to one aspect of the present disclosure, the third elastic body may be elastically deformed after the first elastic body is elastically deformed as the battery holder is displaced with respect to a tool body.

Therefore, after the first elastic body is elastically deformed first, the third elastic body may be elastically deformed to absorb the vibration and impact of the battery.

According to one aspect of the present disclosure, the first elastic body may be held over a body-side recess formed in the tool body and a holder-side recess formed in the battery holder.

Thus, the first elastic body may be held in the recess. This allows for the use of larger elastic bodies or an increase in the number of locations where elastic bodies are placed, thereby enhancing the vibration damping effect without increasing the size of the electric power tool.

According to one aspect of the present disclosure, both the body-side recess and the holder-side recess are provided with upper and lower walls for restricting the displacement of the first elastic body in the up-down direction. A front wall is provided for restricting the frontward displacement of the first elastic body in one of the body-side recess and the holder-side recess and a rear wall is provided for restricting the displacement of the rearward displacement of the first elastic body in the other one of the body-side recess and the holder-side recess.

Thus, the displacement of the first elastic body in the up-down direction and in the front-rear direction are restricted. As a result, vibration and impact of the battery holder in the up-down direction and front-back direction are absorbed by the elastic deformation of the first elastic body.

According to one aspect of the present disclosure, the first elastic body includes a first part held by the tool body and a second part held by the battery holder. A fragile part, which is more easily elastically deformed than the first and second parts, is provided between the first and second parts.

Therefore, since the fragile part is easily elastically deformed, the battery holder is displaced with respect to the tool body such that the vibration and impact of the battery can be effectively absorbed.

According to one aspect of the present disclosure, a guide portion is provided to support the battery holder in a displaceable manner in the front-rear direction with respect to the tool body. A first elastic body is interposed on a front side and a rear side of the guide portion, respectively.

Therefore, the first elastic body more efficiently deforms elastically in the front-rear direction such that the vibrations and impact of the battery holder and the battery can be efficiently absorbed.

According to one aspect of the present disclosure, the tool body is provided with an upward restricting portion that restricts the upward displacement of the battery holder.

Therefore, the rear side of the battery holder is restricted from displacing upward when, for example, the electric power tool is dropped. As a result, the battery holder is smoothly displaced frontward in the event of a drop, and the impact on the battery is efficiently absorbed.

According to one aspect of the present disclosure, the first elastic body has a front first elastic body and a rear first elastic body. The front first elastic body has a front part held by the tool body and a rear part held by the battery holder. The rear first elastic body has a rear part that is held by the tool body and a front part that is held by the battery holder.

Therefore, the two front and rear battery holder side holding portions are placed between the two front and rear tool body side holding portions. This allows the two front and rear battery holder side holding portions to be compactly arranged.

According to one aspect of the present disclosure, the tool body includes a body housing having a left and right halved structure.

Therefore, the battery holder is interposed and held between the left and right halved structure of the main housing. This improves the ease of assembly of the battery holder to the main body housing.

According to one aspect of the present disclosure, the electric power tool may be a driving tool. The driving tool includes a driver that moves in a driving direction and strikes a driven member. An electric motor serves as a driving source to move the driver in the driving direction.

Thus, the vibration damping property and impact resistance of the battery is improved in electric driving tools.

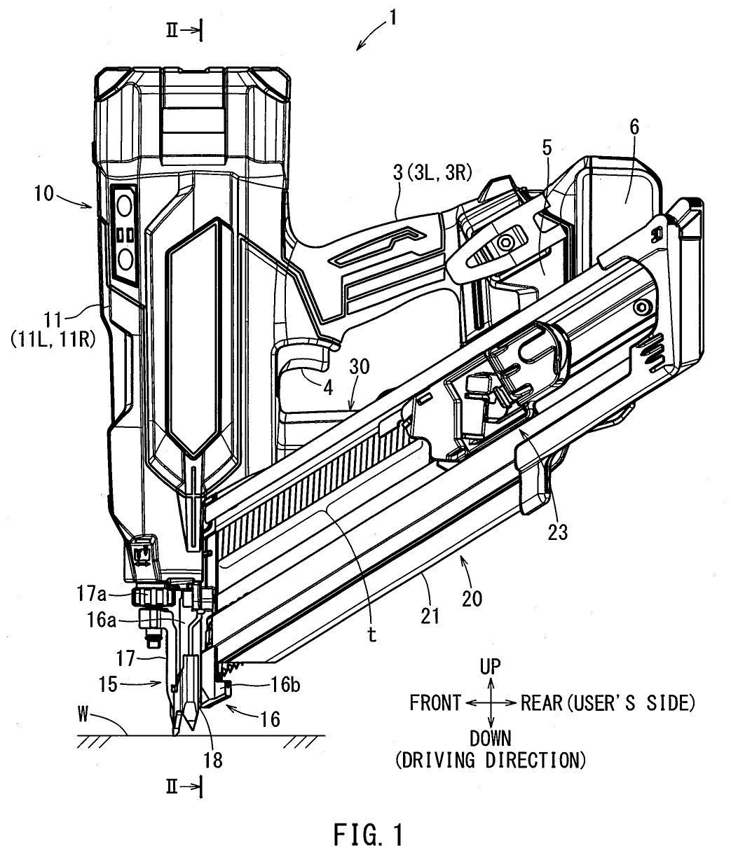

An example of the present disclosure is a gas spring type driving tool. The gas spring type driving tool uses gas pressure in a pressure accumulation chamber above a cylinder as thrust to drive driven members t. For example, rod-shaped nails may be used as the driven members. In the following description, the driving direction of the driving member t is referred to as a downward direction and a counter-driving direction is referred to as an upward direction. A user of the electric power tool 1 is positioned on a right side (grip 3 side) of the electric power tool 1 in FIG. 1. A side in front of the user is referred to as a rearward direction (user's side), and a side opposite the front side is referred to as a frontward direction. Left-right direction is based on the user grasping the grip 3.

As shown in FIGS. 1 to 3, the electric power tool 1 has a tool body 10. The tool body 10 has a main body housing 11 made of resin. The main body housing 11 has a left and right halved structure with left and right housing halves 11L, 11R mutually facing each other and screwed together. A cylinder 12 is housed in the main body housing 11. A piston 13 is reciprocally housed in the cylinder 12 in the up-down direction. A long driver 2 is coupled to a center of a lower surface of the piston 13. A lower side of the driver 2 enters a driving channel 16c, which will be described later. An upper part of the cylinder 12 above the piston 13 is communicated to a pressure accumulation chamber 14. The pressure accumulation chamber 14 is filled with compressed gas, such as, for example, air. The gas pressure in the pressure accumulation chamber 14 acts as a thrust force on an upper surface of the piston 13 to move downward.

A nose 15 is provided at a lower part of the tool body 10. The nose 15 has a driver guide 16 and a contact arm 17. The driver guide 16 has a front guide 16a on the front side and a rear guide 16b on the rear side. The front guide 16a and the rear guide 16b are mutually coupled to form the driver guide 16. A driving channel 16c is formed between the front guide 16a and the rear guide 16b. The driving channel 16c communicates with an inner circumferential chamber of the cylinder 12. The driver 2 enters the driving channel so as to reciprocally move up and down.

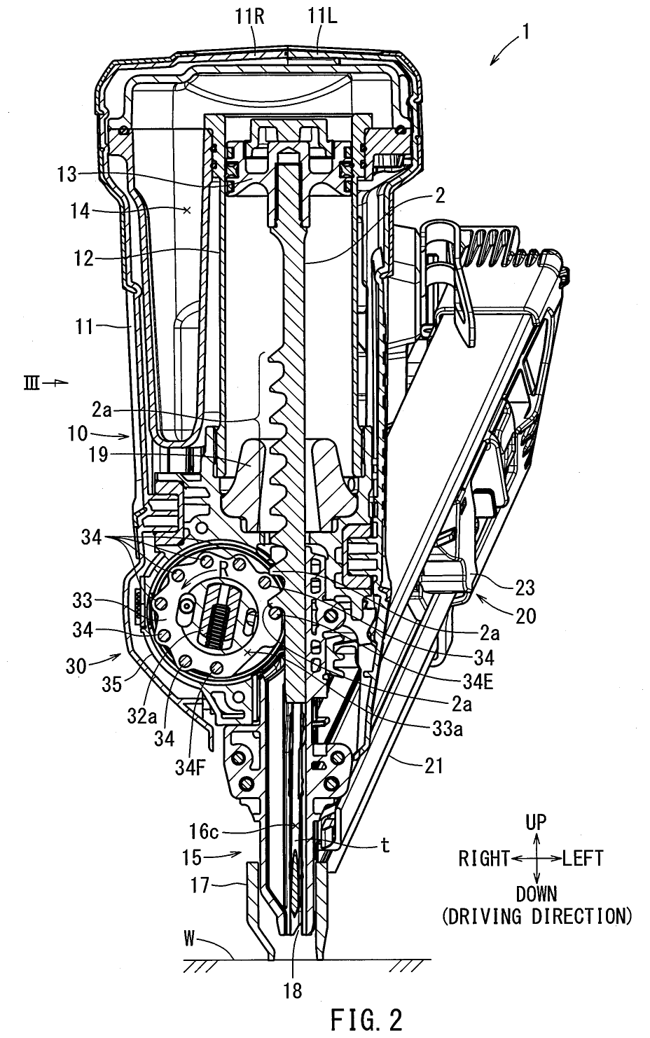

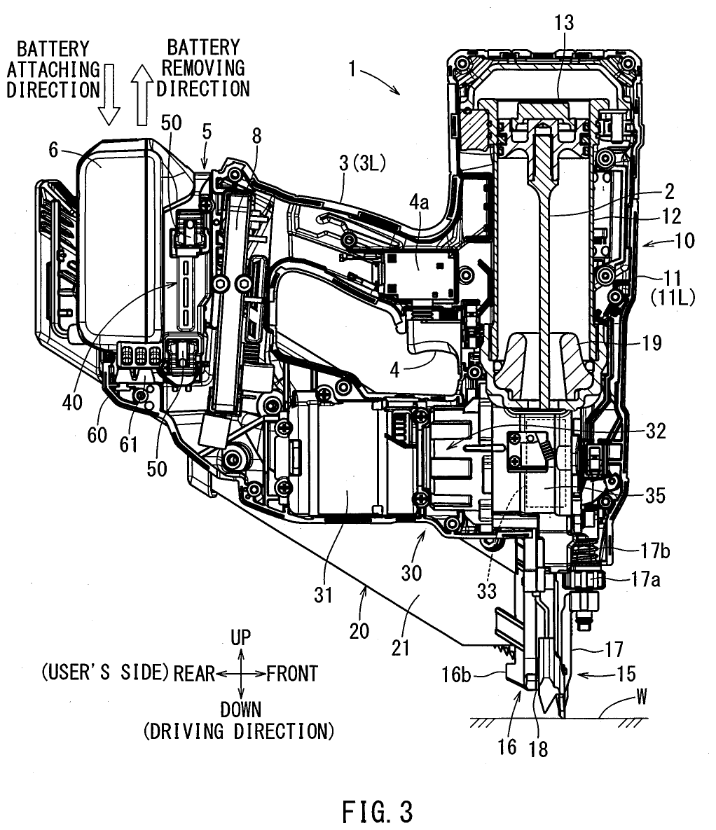

A contact arm 17 is supported on the driver guide 16 in an upwardly/downwardly displaceable manner. The contact arm 17 extends upward from a periphery of a lower end (ejection port 18) of the driver guide 16. As shown in FIG. 3, the contact arm 17 is biased downward to an OFF position by a compression spring 17b. As shown in FIG. 2, in the OFF position, a lower end of the contact arm 17 is located below the ejection port 18.

As shown in FIG. 3, pressing the contact arm 17 against a workpiece W and moving it relatively upward (ON operation) enables a pulling operation of a switch lever 4. A dial 17a for adjusting a driving depth is provided below the compression spring 17b. By rotating the dial 17a, the OFF position of the contact arm 17 can be displaced upward and downward. This changes a stroke of the contact arm 17 and a position of the ejection port 18 with respect to the workpiece W during the ON operation. As a result, the driving depth of the driven member t into the workpiece W is adjusted.

As shown in FIG. 1, a magazine 20 is coupled to a rear side of the nose 15. A plurality of driven members t is loaded into the magazine 20. The magazine 20 has a magazine body 21 and a pusher 23. The magazine body 21 accommodates the plurality of driven members t. The pusher 23 pushes the driven members t toward the driving channel 16c in the nose 15. One driven member t fed into the driving channel 16c is struck by the downwardly moving driver 2 and ejected from the ejection port 18.

A grip 3 is provided on a rear side of the tool body 10 for the user to grasp. The grip 3 has a halved structure in which the left and right grip housings 3L, 3R, provided integrally in the main body housing 11 face each other and are screwed together. On a front bottom surface of the grip 3, a switch lever 4 is provided for activation, which is pulled by a fingertip of the user. As shown in FIG. 3, a switch body 4a is provided inside above the switch lever 4. When the switch lever 4 is pulled upward, the switch body 4a turns ON. When the switch body 4a is turned ON, power is supplied to a lift mechanism 30, which will be described later.

As shown in FIG. 3, a rear of grip 3 has a battery mount 5 to mount the battery 6. The battery 6 is slidably moved downward to attach to the battery mount 5 and slidably moved upward to remove from the battery mount 5. The battery 6 can be used repeatedly by being removed from the battery mount 5 and charged with a separately prepared charger. The battery 6 is versatile enough to be used as a power source for other electric power tools. An electric motor 31 for the lift mechanism 30 operates using the battery 6 as a power source.

A rectangular flat-plate controller 8 is provided within the battery mount 5. The controller 8 is located along a front side of the mounted battery 6. The lift mechanism 30 is activated by the ON-operation of the switch lever 4 and the contact arm 17 to start the driving operation. The controller 8 mainly controls the operation of the electric motor 31 of the lift mechanism 30.

As shown in FIG. 2, a downward motion end damper 19 is disposed at a lower part of the cylinder 12 to absorb impact at a downward motion end of the piston 13. A lower part of the driver 2 passes through an inner peripheral side of the downward motion end damper 19 and enters the driving channel 16c. The driver 2 moves downward in the driving channel 16c by the gas pressure in the pressure accumulation chamber 14 acting on an upper surface of the piston 13. An end (lower end) of the driver 2 strikes one driven member t fed into the driving channel 16c. When the piston 13 reaches the downward motion end, the driven member t is ejected from the ejection port 18. The ejected driven member t is driven into the workpiece W.

The lift mechanism 30 is provided below the grip 3. The lift mechanism 30 has an electric motor 31 as a drive source. One wheel 33 is supported in front of the electric motor 31 via a reduction gear train 32. A mechanism case 35 encloses the wheel 33. The driver 2 and piston 13, which have reached the downward motion end, are returned by the lift mechanism 30 to the upper stand-by position (opposite to the driving direction of the driven member t). The wheel 33 is supported on an output shaft 32a of the reduction gear train 32. The wheel 33 rotates in a direction indicated by an arrow R in FIG. 2 (counterclockwise direction in FIG. 2). This causes the driver 2 to return upward (counter-driving direction).

As shown in FIG. 2, for example, nine engaging portions 2a may be provided on a right side of the driver 2. Each engaging portion 2a has a rack-tooth configuration projecting to the right. The plurality of engaging portions 2a are arranged at regular intervals (for example constant interval) in the longitudinal (up-down) direction of the driver 2. The wheel 33 of the lift mechanism 30 sequentially engages with the plurality of engaging portions 2a.

The wheel 33 is located on the right side of the driver 2. The wheel 33 may have, for example, nine engaging portions 34 that are sequentially engaged with the engaging portions 2a of the driver 2. A cylindrical shaft member is used for each engaging portion 34. The nine engaging portions 34 are spaced at regular intervals (for example, constant interval) along an outer peripheral edge of the wheel 33. The first engaging portion 34 to engage the engaging portion 2a of the driver 2 that has reached the downward motion end by the rotational movement of the wheel 33 in the direction of the arrow R is denoted with the reference number 34F, and the last engaging portion 34 is denoted with the reference number 34E to distinguish them from each other as necessary. A significant load is added to the last engaging portion 34E at the stage where the driver 2 moves upward from the stand-by position to the upward motion end position and then the driver 2 is disengaged. Therefore, sufficient lubrication must be provided, particularly for the last engaging portion 34E.

The driving operation brings driver 2 to the downward motion end. Thereafter, the wheel 33 rotates in the direction of arrow R as the electric motor 31 is activated. The engaging portions 34 are successively engaged with the engaging portions 2a of the driver 2 from below. This causes the driver 2 to return upward. The gas pressure in the pressure accumulation chamber 14 is increased. The driver 2 is returned to the stand-by position shown in FIG. 2 (the position where the last engagement portion 34E engages the engaging portion 2a of the driver 2). At this time, the electric motor 31 stops and the series of striking operations is completed.

When the switch lever 4 is pulled again, the lift mechanism 30 is restarted. This causes the wheel 33 to begin rotating in the direction of arrow R, which lifts the driver 2 and the piston 13 further upward from the stand-by position. This disengages the last engaging portion 34E from the engaging portion 2a of the driver 2.

A relief region 33a is provided between the first engaging portion 34F and the last engaging portion 34E in a rotational direction of the wheel 33 indicated by the arrow R in FIG. 3. There is no engaging portion 34 in the relief region 33a and a large spacing in the rotational direction is provided between the first engaging portion 34F and the last engaging portion 34E. When this relief area 33a is directed toward the driver 2 by rotation of the wheel 33 in the direction of the arrow R, the engagement of the wheel 33 with all engaging portions 2a of the driver 2 is released. This causes the piston 13 and driver 2 to move downward due to the gas pressure in the pressure accumulation chamber 14 acting on the piston 13. The driver 2 strikes the driven member t, and the driven member t is driven into the workpiece W.

As shown in FIGS. 3 to 5, the battery mount 5 supports a battery holder 40. The battery 6 is mounted to the battery mount 5 via the battery holder 40. The battery holder 40 is supported by the battery mount 5 via first four elastic bodies 50.

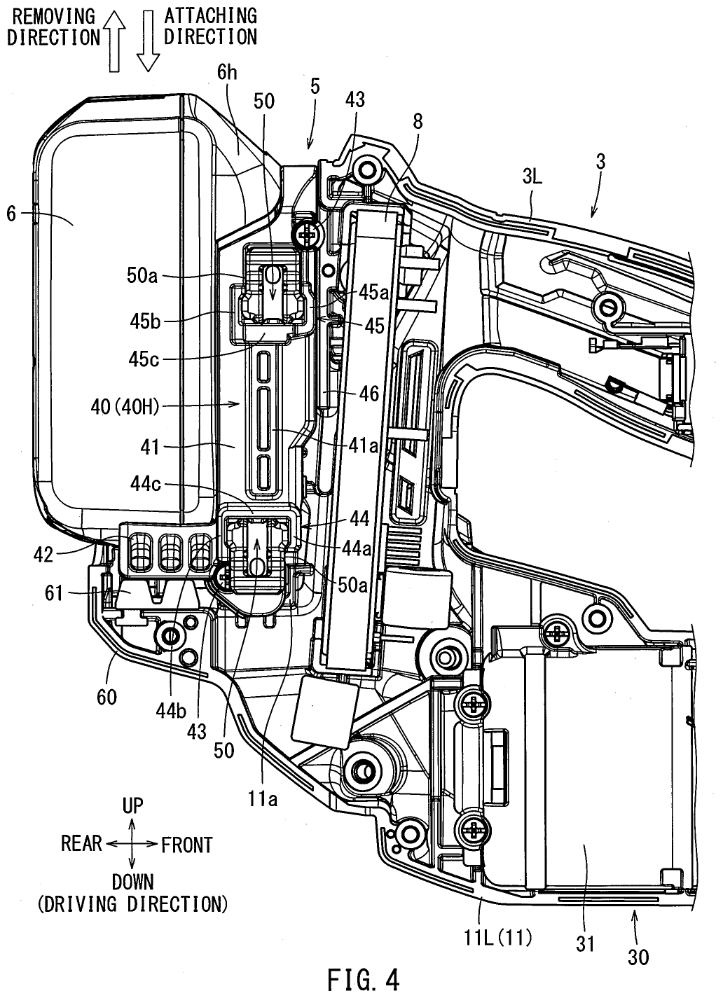

As shown in FIGS. 4 to 7, the battery holder 40 has a holder main body 40H and a terminal 51. The holder main body 40H has an up-down extension 41 that is extendable in an up-down direction and a holder lower portion 42 that is extendable in a front-back direction. The holder lower portion 42 extends rearwardly from the lower part of the up-down extension 41. The holder lower portion 42 faces a lower surface of the mounted battery 6. The holder main body 40H has two parts, left holder half 40L and right holder half 40R, which are connected at two locations in the front and rear to form a single unit by coupling screws 43.

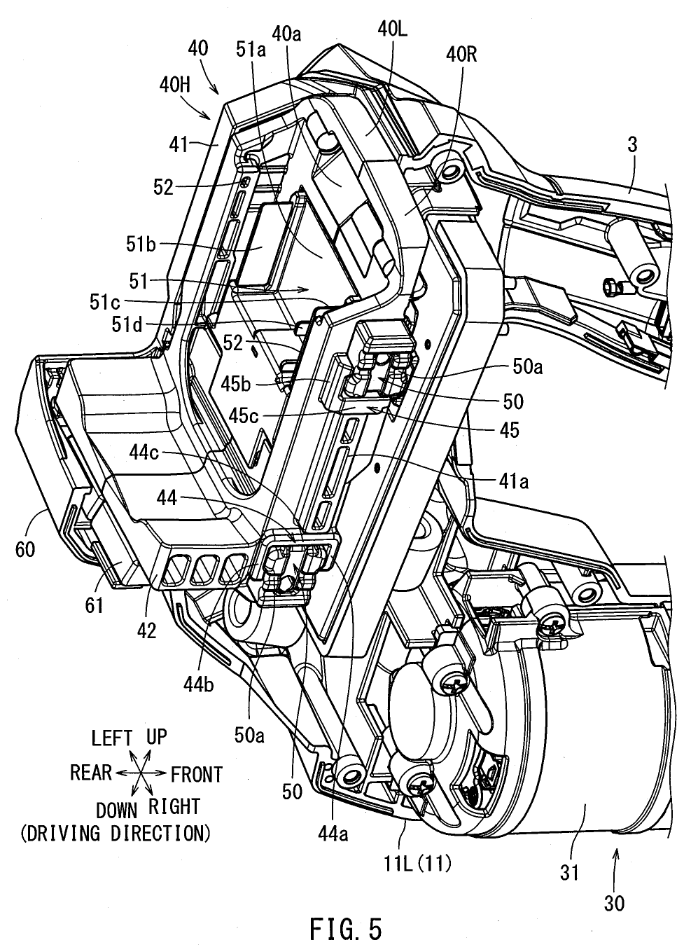

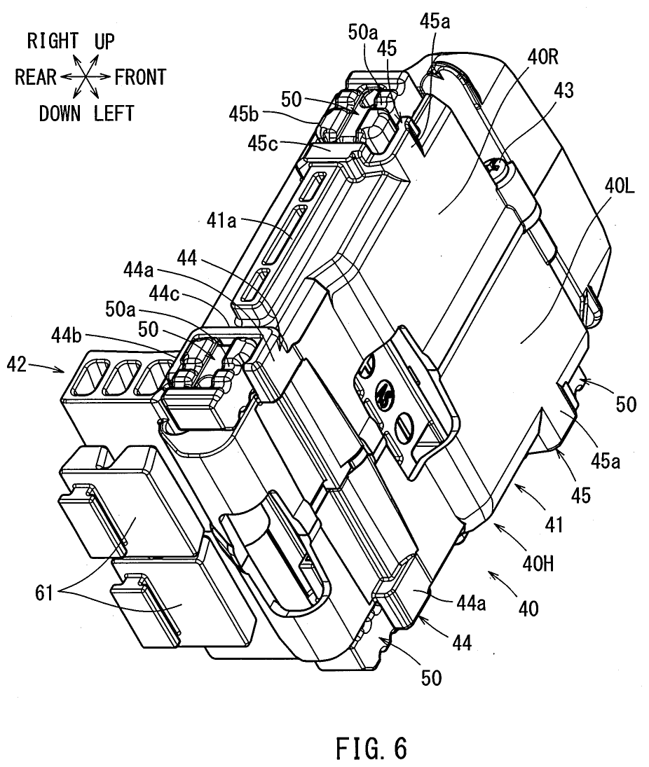

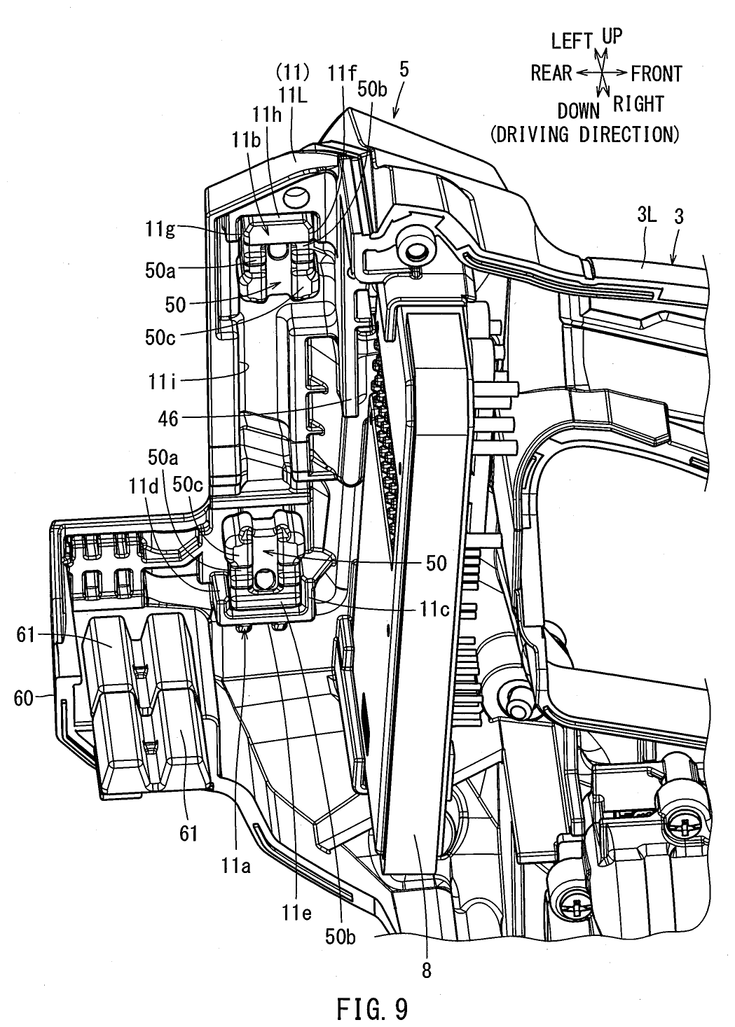

As shown in FIGS. 5 and 6, the up-down extension 41 has guide portions 41a on both left and right outer portions. The guide portions 41a are extendable in an up-down direction. As shown in FIG. 9, the main body housing 11 has guide receiving portions 11i on its inner surface to receive the guide portions 41a of the battery holder 40. The guide receiving portions 11i are provided to face each other on inner left and right sides of the main body housing 11. The guide portions 41a are respectively received by the guide receiving portions 11i to allow the battery holder 40 to displaceably supported to the main body housing 11 in an up-down direction (battery 6 mounting and removing direction).

As shown in FIGS. 4 and 5, the first elastic bodies 50 are held on both lower and upper sides of the guide portions 41a, respectively. Two of a total of four first elastic elements 50 are held in the front and rear on the left and right sides in mutually identical configurations, respectively. The first four elastic bodies are made of elastic rubber and are formed in a generally rectangular (hexahedral) shape.

As shown in FIGS. 4 to 7, the up-down extensions 41 has two holder-side recesses 44 and 45 arranged on a right side. The lower holder-side recess 44 has a front wall 44a, a rear wall 44b, and an upper wall 44c, and has a downwardly opening U-shaped. The upper holder-side recess 45 has a front wall 45a, a rear wall 45b, and a lower wall 45c, and has an upwardly opening U-shape.

Still in FIGS. 4 to 7, an upper part (second part 50c) of a lower first elastic body of the first elastic bodies 50 is held in the lower holder-side recess 44. A lower part (second part 50c) of an upper first elastic body of the first elastic bodies 50 is held in the upper holder-side recess 45. The two upper and lower first elastic bodies 50 are arranged with their upper side and lower side reversed. Thus, an upper side and a lower side of a first part 50b and a second part 50c of the first elastic bodies 50 are opposite in orientation in the lower first elastic body of the first elastic bodies 50 and the upper first elastic body of the first elastic bodies 50.

As shown in FIG. 9, inner sides of the left and right housing halves 11L, 11R are provided with two body-side recesses 11a, 11b, respectively. The two body-side recesses 11a, 11b are located apart on upper and lower sides. The lower body-side recess 11a has an upwardly opened U-shape with a front wall 11c, a rear wall 11d, and a lower wall 11e. The upper body-side recess 11b has a downwardly opened U-shape with a front wall 11f, a rear wall 11g, and an upper wall 11h.

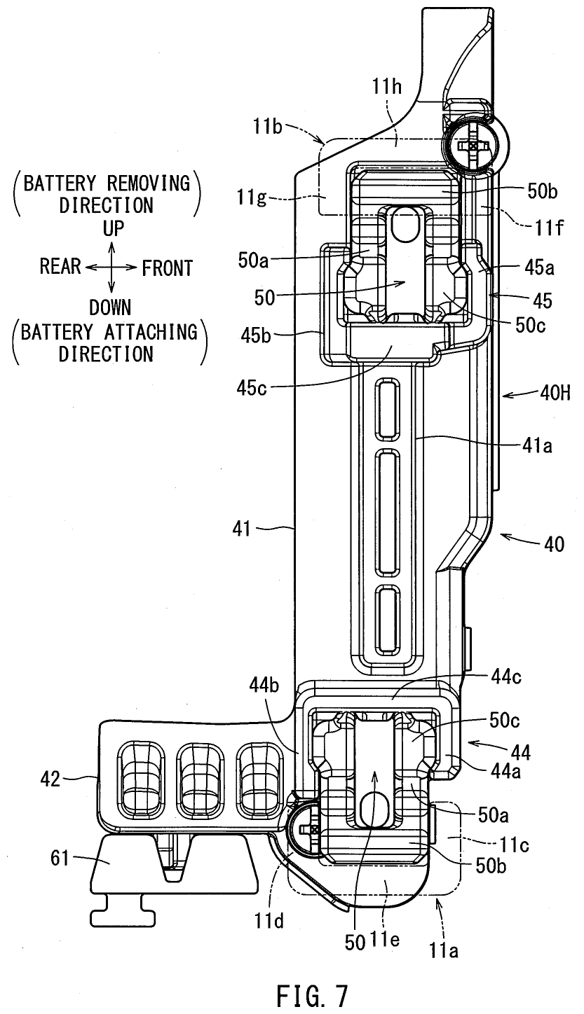

As shown in FIG. 7, the lower part (first part 50b) of the lower first elastic body of the first elastic bodies 50 is held in the lower body-side recess 11a. The upper part (first part 50b) of the upper first elastic body of the first elastic bodies 50 is held in the upper body-side recess 11b. The first elastic body 50 is held over the body-side recess 11a (11b) formed in the tool body 10 and the holder-side recess 44 (45) formed in the battery holder 40.

The lower first elastic body of the first elastic bodies 50 is interposed between the front wall 11c and the rear wall 11d of the body-side recess 11a as well as between the front wall 44a and the rear wall 44b of the holder-side recess 44 to restrict displacement in the front-back direction. The upper first elastic body of the first elastic bodies 50 is interposed between the front wall 11f and the rear wall 11g of the body-side recess 11b as well as between the front wall 45a and the rear wall 45b of the holder-side recess 45 to restrict displacement in the front-back direction.

The lower wall 11e of the lower body-side recess 11a restricts the downward displacement of the lower first elastic body of the first elastic bodies 50. The upper wall 44c of the lower holder-side recess 44 restricts the upward displacement of the lower first elastic body of the first elastic bodies 50. The upper wall 11h of the upper body-side recess 11b restricts the upward displacement of the upper first elastic body of the first elastic bodies 50. The lower wall 45c of the upper holder-side recess 45 restricts the downward displacement of the upper first elastic body of the first elastic bodies 50.

The first elastic body 50 includes a first part 50b which is held on the tool body 10 side, and a second part 50c which is held on the battery holder 40 side. A fragile part 50a that is more easily elastically deformed than a first part 50b and a second part 50c is provided between the first part 50b and the second part 50c. In this example, a groove is provided on the side between the first part 50b and the second section 50c as the fragile part 50a. The fragile part 50a facilitates elastic deformation of the first elastic bodies 50 to allow the battery holder 40 to be easily displaced, especially downward in the mounting direction.

As shown in FIG. 4 and FIG. 9, the inner surfaces of the left and right housing halves 11L and 11R are provided with frontward restricting portions 46 that restrict the frontward displacement of mainly an upper part of the battery holder 40. The left and right frontward restricting portions 46 are provided in front of the up-down extensions 41 of the battery holder 40 so as to extend upward and downward.

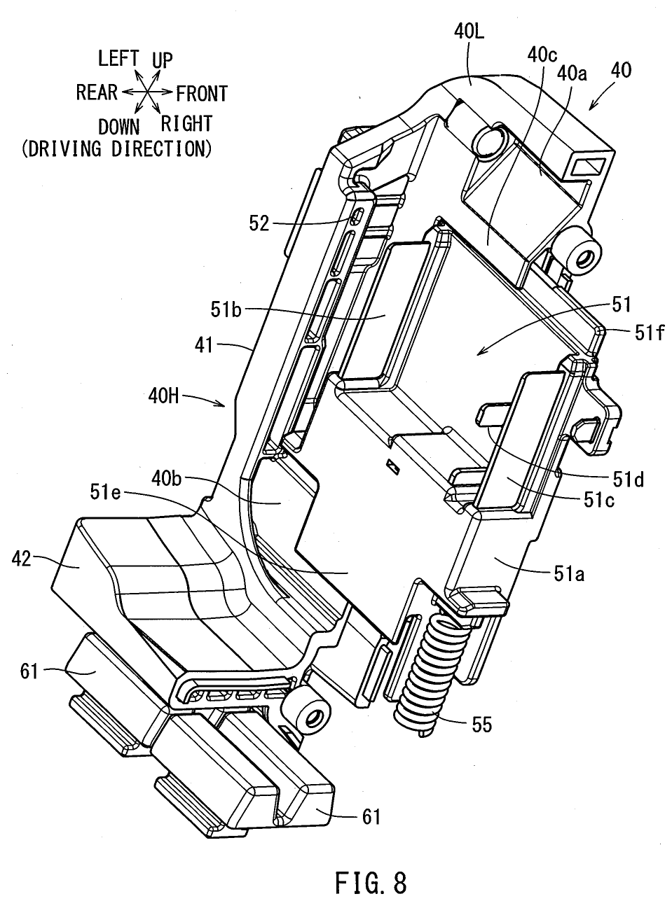

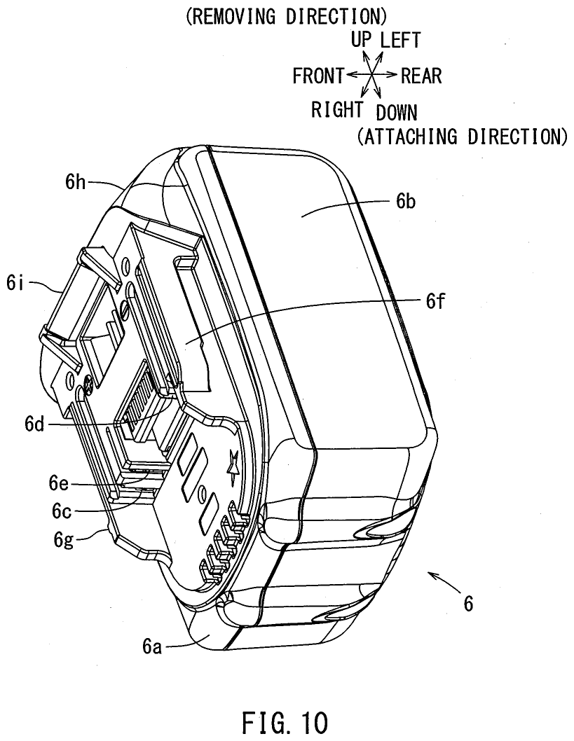

As shown in FIG. 8, a terminal 51 is supported on a rear side of the up-down extension 41 of the holder main body 40H. Slide rails 52 are provided on left and right sides of the terminal 51 to movably guide the battery 6 relative to the battery holder 40. FIG. 10 shows the removed battery 6 alone. The battery 6 is a slide-mounting type lithium-ion battery and has a substantially hexahedral box shape. The battery 6 has a front upper housing 6a and a rear lower housing 6b. The upper housing 6a has a substantially flat plate shape, while the lower housing 6b has a front-opened case body. The upper housing 6a is coupled to a front of the lower housing 6b so as to close the opening of the lower housing 6b. The upper housing 6a serves as a lid to close the opening of the lower housing 6b.

As shown in FIG. 10, the upper housing 6a is provided with a positive terminal receptacle 6c and a negative terminal receptacle 6d. A number of battery cells (not visible in the figure) are housed in the lower housing 6b. A control terminal receptacle 6e for sending and receiving control signals is provided between the positive terminal receptacle 6c and the negative terminal receptacle 6d.

Still in FIG. 10, a pair of left and right rail receiving portions 6f and 6g are provided in the upper housing 6a. The right rail receiving portion 6g is provided on a right side of the positive terminal receptacle 6c. The left rail receiving portion 6f is provided on a left side of the negative terminal receptacle 6d. The battery 6 is slidably moved to allow the slide rail 52 of the battery holder 40 to enter along the front of the left and right rail receiving portions 6f, 6g so as to be mounted on the battery mount 5. Frontward displacement of the battery 6 (in a direction perpendicular to the mounting direction) is restricted as the slide rail 52 enters the front of the rail receiving portions 6f, 6g, respectively.

A step 6h is integrally formed in an upper part of the upper housing 6a. The step 6h protrudes frontward. The step 6h has a substantially ridge shape in a side view. One hook 6i is provided on a lower side of the step 6h. The hook 6i is provided so as to be displaceable frontward and rearward with respect to the step 6h. The hook 6i is biased toward a locking position projecting frontward. The hook 6i can be pushed down to a rearward unlocked position by pushing down an unlock button (not visible in the figure) provided on the upper side of the step 6h against a spring biasing force. The hook 6i is inserted into the locking recess 40a (see FIG. 5 and FIG. 8) formed in the upper part of the battery holder 40, thereby locking the battery 6 in the mounted position.

As shown in FIG. 8, the terminal 51 has a base 51a, a positive terminal 51b, a negative terminal 51c, and a control terminal 51d. The base 51a has a lower rail 51c and an upper rail 51f located on both lower and upper parts of the base 51a, respectively. The lower rail 51e contacts a rear side of a restricting plate 40b provided on a lower part of the battery holder 40. The upper rail 51f is held in a bifurcated holding portion 40c provided in an upper part of the battery holder 40. As a result, the terminal 51 is supported in an upwardly/downwardly displaceable manner. The positive terminal 51b is connected to the positive terminal receptacle 6c of the battery 6 and the negative terminal 51c is connected to the negative terminal receptacle 6d of the battery 6 by slidably moving the battery 6 downward against the upward/downward displaceably supported terminal 51. The battery 6 is thus electrically connected to the battery mount 5.

As shown in FIG. 8, the terminal 51 is being biased in a direction to be returned upward by two of the second elastic bodies 55 on both left and right sides. A compression spring is used for the second elastic body 55. These two second elastic bodies 55 are interposed between the base 51a and the battery holder 40. The biasing force of the second elastic bodies 55 does not act on the terminal 51 in its normal position of use. If, for example, the battery 6 is subjected to a significant impact when the electric power tool 1 is dropped, the biasing force of the second elastic bodies 55 acts on the terminal 51 when the terminal 51 is displaced significantly downward beyond its normal position of use. The terminal 51 is thus returned to its normal position of use.

As shown in FIGS. 4, 5, and 9, the main body housing 11 has a main body extension 60 at a rear portion. The main body extension 60 extends below the holder lower portion 42 of the battery holder 40. Third elastic bodies 61 are attached over a large area of the upper surface of the main body extension 60. Each of the third elastic bodies 61 is disposed in contact with the holder lower portion 42 with almost no gap. For example, when the battery 6 is subjected to a significant impact when the electric power tool 1 is dropped, the majority of impact is absorbed as the holder lower portion 42 contacts the third elastic body 61.

Still in FIGS. 4, 5, and 9, the third elastic bodies 61 are made of a material having a higher elastic modulus than the first elastic bodies 50. If the electric power tool 1 is dropped, etc., the first elastic bodies 50 are first elastically deformed and the battery holder 40 is displaced. After the displacement due to the elastic deformation of the first elastic bodies 50, the holder lower portion 42 of the battery holder 40 contacts the third elastic bodies 61 to absorb the impact.

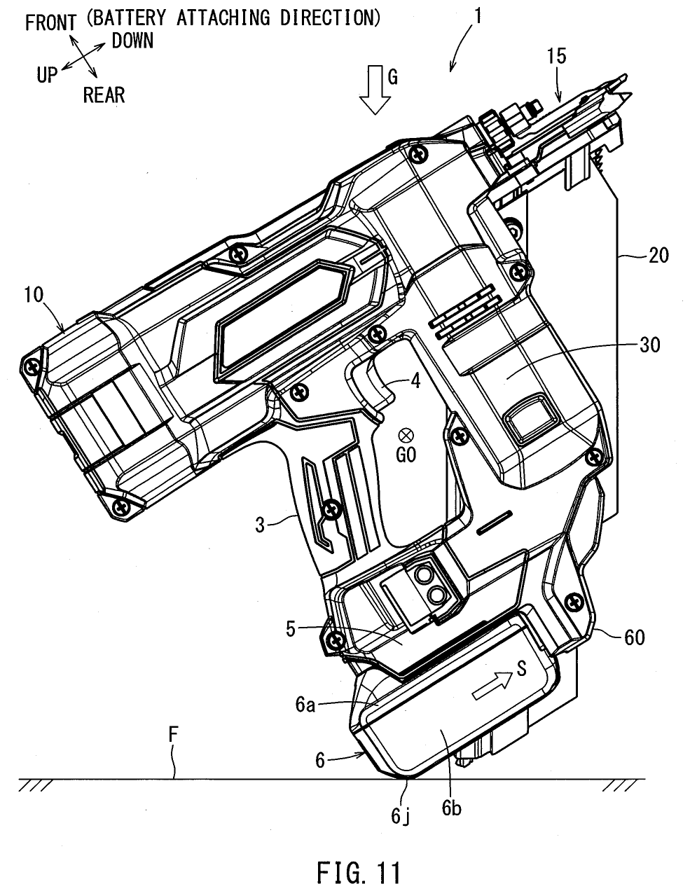

FIG. 11 shows the electric power tool 1 dropped on the floor F. A reference numeral G0 in FIG. 11 shows the approximate center of gravity of the electric power tool 1 with the battery 6 mounted on the battery mount 5. When the battery 6 is dropped freely in the direction of gravity G with a rear corner 6j of the lower housing 6b of the battery 6 oriented downward as illustrated, it is anticipated that the rear corner 6j will first collide with the floor surface F. At the time of collision, the rear corner 6j of the battery 6 is subjected to the impact load by the entire weight of the electric power tool 1 since the center of gravity G0 of the electric power tool 1 is located on or near the perpendicular line passing through the rear corner 6j. This impact load acts on the battery 6 as an impact S in the direction indicated by a void arrow (mounting direction).

The battery 6 is displaced downward due to the impact S from the drop. As the battery 6 is displaced downward with respect to the battery mount 5, the battery holder 40 is displaced downward with respect to the battery mount 5 while the first elastic body 50 is elastically deformed. As the battery 6 is displaced downward with respect to the battery mount 5, the terminal 51 is displaced downward with respect to the holder main body 40H while the second elastic body 55 is elastically deformed.

As the battery holder 40 is displaced downward with respect to the battery mount 5, the holder lower portion 42 contacts the third elastic bodies 61. As a result, the impact S in the event of a drop is absorbed as the third elastic bodies 61 are elastically deformed. Thus, for example, when the electric power tool 1 is dropped, the battery holder 40 and terminal 51 are allowed to displace downward, while the holder lower portion 42 of the battery holder 40 contacts the third elastic bodies 61 and the majority of impact S is absorbed.

Therefore, the impact S applied to the battery 6 in the event of a drop, is absorbed as the lower housing 6b side contacts the third elastic bodies 61, not the upper housing 6a, which is mechanically and electrically connected to the battery holder 40 and the terminal 51. This significantly reduces the shear force acting on the battery 6 in the direction that separates the upper housing 6a from the lower housing 6b in the up-down direction when the battery is dropped. This prevents damage to the battery cells. This avoids damage to the battery cells and enhances the durability of the battery 6.

The battery holder 40, which was displaced downward by the impact S, is returned to its normal position of use by the biasing force of the first elastic body 50. The terminal 51, which was displaced downward by the impact S, is returned to its normal position of use by the biasing force of the second elastic bodies 55.

According to the embodiment, the first elastic bodies 50 are interposed between the battery holder 40 and the tool body 10. The battery holder 40 is supported by the first elastic bodies 50 in a displaceable or movable manner with respect to the tool body 10 in the battery mounting direction. The second elastic bodies 55 are interposed between the battery holder 40 and the terminal 51. The terminal 51 is supported by the second elastic bodies 55 in a displaceable or movable manner with respect to the holder main body 40H of the battery holder 40 in the battery mounting direction. The third elastic bodies 61 are interposed between the battery holder 40 and the tool body 10.

Therefore, the first to third elastic bodies 50, 55, 61 are distributed in three locations to reduce vibration of the battery 6 during use and, for example, to absorb impact S to the battery 6 when the electric power tool 1 is dropped. This improves the vibration damping property and impact resistance of the battery 6 without increasing the size of the electric power tool 1.

According to the embodiment, the third elastic bodies 61 are elastically deformed after the first elastic bodies 50 were elastically deformed caused by the displacement of the battery holder 40 with respect to the tool body 10.

Thus, after the first elastic bodies 50 are elastically deformed first, the third elastic bodies 61 are elastically deformed to absorb the vibration and impact of the battery 6.

According to the embodiment, the first elastic bodies 50 are held over the body-side recesses 11a, 11b formed in the main body housing 11 of the tool body 10 and the holder-side recesses 44, 45 formed in the battery holder 40.

Thus, the first elastic bodies 50 fit into the body-side recesses 11a, 11b and the holder-side recesses 44, 45 to be held. This may increase vibration damping property without increasing the size of the electric power tool 1 using a larger elastic body or by increasing the number of locations where the elastic body is placed.

According to the embodiment, both the body-side recesses 11a, 11b and the holder-side recesses 44, 45 are provided with front and rear walls 11c, 11d, 11f, 11g, 44a, 44b, 45a, 45b that restrict the displacements of the first elastic bodies 50 in the front-back direction. Lower walls 11e, 45c are provided in the lower body side recess 11a and the upper holder-side recess 45, respectively, which restrict the downward displacement of the first elastic bodies 50. Upper walls 11h, 44c are provided in the upper body-side recess 11b and the lower holder-side recess 44, respectively, which restrict the upward displacements of the first elastic bodies 50.

Thus, the displacements of the first elastic bodies 50 in the front-back and up-down direction may be restricted.

According to the embodiment, each of the first elastic bodies 50 has a first part 50b held on the tool body 10 side, a second part 50c held on the battery holder 40 side, and a fragile part 50a provided between the first part 50b and the second part 50c and more easily deformed elastically than the first part 50b and the second parts 50c.

Therefore, since the fragile part 50a is easily elastically deformed, the battery holder 40 is displaced with respect to the tool body 10 such that the vibration and impact of the battery can be effectively absorbed.

According to the embodiment, a guide portion 41a is provided to support the battery holder 40 displaceable with respect to the tool body 10 in an up-down direction (in the direction of mounting and removing the battery 6), and the first elastic body 50 is interposed in the lower and upper portions of the guide portion 41a, respectively.

Thus, the first elastic body 50 deforms up and down more efficiently and effectively absorbs the vibration and impact of the battery holder 40 and battery 6.

According to the embodiment, the tool body 10 is provided with a frontward restricting portion 46 that restricts the frontward displacement of the battery holder 40 mainly on the upper side.

Therefore, the upper side of the battery holder 40 is restricted from being displaced frontward when the electric power tool 1 is dropped. As a result, the battery holder 40 is smoothly displaced downward and the impact S to the battery 6 is efficiently absorbed.

According to the embodiment, a lower first elastic body 50 and an upper first elastic body 50 are provided as the first elastic body 50. The lower first elastic body 50 has a lower part (first part 50b) held on the tool body 10 side and an upper part (second part 50c) held on the battery holder 40 side. The upper first elastic body 50 has an upper part (first part 50b) held on the tool body 10 side and a lower part (second part 50c) held on the battery holder 40 side.

Accordingly, the two upper and lower holder-side recesses 44, 45 on the battery holder 40 side are disposed between the two upper and lower body-side recesses 11a, 11b on the tool body 10 side. This allows the two upper and lower holder-side recesses 44, 45 to be compactly arranged in the up-down direction. This allows for a more compact design of the battery holder 40 in the up-down direction.

According to the embodiment, the tool body 10 has a main body housing 11 with a left and right halved structure, and the battery holder 40 also has holder halves 40L, 40R with a left and right halved structure.

Accordingly, the battery holder 40 is interposed and held between the housing halves 11L, 11R having the left and right halved structure. Also, the terminal 51 is interposed and held between the holder halves 40L, 40R having the left and right halved structure. This improves the ease of assembly of the battery holder 40 and the terminal 51 to the main body housing.

According to the embodiment, the electric power tool 1 is a driving tool having a driver 2 that moves in the driving direction to strike the driven member t by gas pressure, a wheel 33 that returns the driver 2 in a direction opposite to the driving direction, and an electric motor 31 that rotates the wheel 33.

Therefore, by applying the elastic support structure of the battery holder 40 and terminal 51 with the first to third elastic bodies 50, 55, 61 interposed in the gas spring type driving tool, the vibration damping property and impact resistance of the battery 6 can be further enhanced.

Various modifications may be made to the above-described embodiments. For example, although the example shows a configuration in which the first elastic bodies 50, 50 are disposed in two up-down locations on both the left and right sides, it may be configured to have one first elastic body disposed on both the left and right sides, or to have three or more first elastic bodies disposed on each of both the left and right sides.

Although the first elastic bodies 50 made of rubber have been described in the embodiments, for example, a compression spring may be used as the first elastic body.

Although the configuration in which each of the first elastic bodies 50 is interposed and held between the body-side recesses 11a, 11b and the holder-side recesses 44, 45 in the up-down direction has been described in the embodiments, it may also be interposed and held from both the left and right sides.

Although the configuration to provide a groove as the fragile part 50a has been described in the embodiments, a circular recess or through hole may also be provided as a fragile part.

While a gas spring type driving tool has been illustrated as the electric power tool 1, the elastic support structure of the battery holder 40 using the first to third elastic bodies 50, 55, 61, as illustrated for the battery mount in a mechanical spring type driving tool using a biasing force of a compression spring as a thrust force for driving may also be applied. Further, the elastic support structure of the battery holder 40 illustrated for an electric pneumatic type or flywheel type electric driving tool may also be applied. Furthermore, the elastic support structure of the battery holder 40 illustrated for other forms of battery-powered tools such as drilling tools, polishing, grinding tools, screw tightening tools, cutting tools or gardening tools, handy cleaners, etc. may also be applied.

What is claimed is:

1. An electric power tool comprising:
a tool body;
a battery holder having a holder main body to support the battery holder in a displaceable manner that is in an up-down direction with respect to the tool body;
a terminal having a connection terminal, wherein the terminal is supported by the holder main body in a displaceable manner in an up-down direction with respect to the holder main body;
a first elastic body configured to be interposed between the tool body and the battery holder;
a second elastic body configured to be interposed between the holder main body and the terminal, and
a third elastic body arranged on the tool body configured to face a lower surface of a battery that is movable downward from a top relatively to the battery holder so as to be mountable to the battery holder.

2. The electric power tool according to claim 1, wherein the third elastic body is elastically deformed after the first elastic body is elastically deformed as the battery holder is displaced with respect to the tool body.

3. The electric power tool according to claim 2, wherein the first elastic body is held over a body-side recess that is formed in the tool body and a holder-side recess that is formed in the battery holder.

4. The electric power tool according to claim 3, wherein the body-side recess and the holder-side recess are provided with a front wall and a rear wall for restricting the displacement of the first elastic body in a front-rear direction, and
wherein one of the body-side recess and the holder-side recess is provided with a lower wall for restricting a downward displacement of the first elastic body, and the other one is provided with an upper wall for restricting an upward displacement of the first elastic body.

5. The electric power tool according to any one of claim 1, wherein the first elastic body further includes a first part held by the tool body, a second part held by the battery holder, and a fragile part provided between the first part and the second part, and wherein the fragile part is elastically deformed more easily than the first part and the second part.

6. The electric power tool according to any one of claim 1, wherein the battery holder further has a guide portion to support the battery holder in a displaceable manner in the up-down direction with respect to the tool body,
wherein the first elastic body is interposed on a lower side of the guide portion, and
the elastic power tool further comprises another first elastic body that is interposed on an upper side of the guide portion.

7. The electric power tool according to claim 1, wherein the tool body is provided with a frontward restricting portion that restricts a frontward displacement of the battery holder.

8. The electric power tool according to claim 1, further comprising a lower first elastic body as the first elastic body and an upper first elastic body as the first elastic body,
wherein the lower first elastic body has a lower part held by the tool body and an upper part held by the battery holder, and
wherein the upper first elastic body has an upper part held by the tool body and a lower part held by the battery holder.

9. The electric power tool according to claim 1, wherein the tool body further includes a main body housing, and wherein the main body housing has a left and right halved structure.

10. The electric power tool according to claim 1, further comprising:
a driver configured to move in a driving direction to strike a driven member; and
an electric motor configured to serve as a driving source to generate power to move the driver in the driving direction.

11. An electric power tool comprising:
a tool body having a main body housing, wherein the main body housing has a main body extension arranged at a rear side;
a battery mount for mounting a battery;
a battery holder having a holder main body having an up-down extension that is extendable in an up-down direction, the up-down extension has a plurality of guide portions arranged at left and right outer portions;
a terminal having a base, positive terminal, negative terminal, and control terminal;
a plurality of first elastic bodies configured to be held on the plurality of the guide portions and interposed between the tool body and the battery holder;
a plurality of second elastic bodies configured to be interposed between the holder main body and the terminal; and
a plurality of third elastic bodies that are attachable to an upper surface of the main body housing;

12. The electric power tool according to claim 11, wherein the battery supports the battery holder via a first four of the plurality of first elastic bodies.

13. The electric power tool according to claim 11, wherein each of the plurality of first elastic bodies is configured to be interposed on a lower side and an upper side of the plurality of guide portions, respectively.

14. The electric power tool of claim 11, wherein the terminal further has a lower rail and an upper rail located on both lower and upper parts of the terminal, respectively, wherein the lower rail is configured to contact a rear side of a restricting plate on a lower part of the battery holder, and wherein the upper rail is configured to be held in a bifurcated holding portion on an upper part of the battery holder.

15. The electric power tool of claim 11, wherein the up-down extension further has a lower holder-side recess and an upper holder-side recess arranged on a right side.

16. The electric power tool of claim 15, wherein the lower holder-side recess has a front wall, a rear wall, an upper wall, and a U-shaped downwardly opening.

17. The electric power tool of claim 15, wherein the upper holder-side recess has a front wall, a rear wall, and a lower wall, and a U-shaped upwardly opening.

18. The electric power tool of claim 16, wherein an upper part of a lower first elastic body of the plurality of first elastic bodies is configured to be held in the lower holder-side recess.

19. The electric power tool of claim 17, wherein a lower part of an upper first elastic body of the plurality of first elastic bodies is held in the upper holder-side recess.
